(19) United States
(12) Patent Application Publication
(10) Pub. No.: US 2010/0131237 A1
(43) Pub. Date: May 27, 2010

(54) LASER DISTANCE MEASURING GRADE ROD

(76) Inventor: Timothy C. Pamatmat, Forestville, CA (US)

Correspondence Address: STAINBROOK & STAINBROOK, LLP, 412 AVIATION BOULEVARD, SUITE H, SANTA ROSA, CA, 95403, US

(21) Appl. No.: 12/625,443

(22) Filed: Nov. 24, 2009

Related U.S. Application Data
(60) Provisional application No. 61/200,151, filed on Nov. 24, 2008.

(51) Int. Cl. G06F 15/00; G01B 11/14

(52) U.S. Cl. 702/159; 356/4.01

(57) ABSTRACT

A grade rod for use in a laser distance measuring system which provides a measure of distance from the on grade position of an external laser receiver to a user-defined target point without requiring the use of a pole or rod to adjust the position of the external laser receiver on the grade rod or to interpret measurements.

### CROSS REFERENCES TO RELATED APPLICATIONS

The present application claims the benefit of U.S. Provisional Patent Application Ser. No. 61/200,151, filed Nov. 24, 2008 (Nov. 24, 2008).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to grade rods used in the construction and survey industry. More specifically the present invention relates to grade rods integrated into a laser distance measuring system.

2. Discussion of Related Art Including Information Disclosed Under 37 CFR 1.97, 1.98

Laser alignment systems have been used in construction and surveying for years. Typically, a remote laser transmitting device is used to create a reference plane or reference cone, and at least one remote laser light detector is used to locate the position of the plane or cone. The laser light detector is typically attached with a friction clamp to a grade rod and uses a photodetector to provide visual and or audio indicators in the form of up/down arrows and/or tones to assist in centering the laser plane at a predetermined and fixed reference position on the laser light detector, generally referred to as the “on grade” position. After the laser light detector has been positioned on the grade rod such that the laser plane is centered on the on grade position, markings aligned with this position that are on the friction clamp transfer this on grade position to the grade rod which then gives a measure of distance between the laser plane and given point on the target surface. The typical grade rod used to enable this procedure is simply an elongated member with markings spaced evenly, a predetermined distance apart that coincide with a given units and scale.

Prior art grade rods used in construction and survey industry contain several disadvantages. One inherent disadvantage is the need to loosen the frictional guide mount to allow the laser receiver to be slid up and down the grade rod in order to align the laser receiver with the reference plane. Often the laser receiver is brought out of alignment as the frictional mount is tightened as the laser receiver is not concentric with the grade rod and any loosening or tightening of the mount causes the laser receiver to rock about the mounting point. This effect is exasperated due to the fact current laser receivers offer sensitivities up to +/− 1/32″. The situation becomes even more difficult if the laser plane is outside arm's reach (if the user is in a depression such as a hole or ditch.) In this case the laser light detector must be approximately placed on the graduated rod and lifted into the laser plane and if centering is not achieved the graduated rod is lowered in order to adjust the position of the laser light detector and lifted back into the laser plane. This process is repeated until centering is achieved. This is a time consuming process that requires adjusting the laser light detector up and down the graduated rod while monitoring the audio and visual aids until centering is achieved.

Another disadvantage of prior art grade rods is they require the user to obtain several grade rods to handle the numerous units (English, Metric) and scales ( 1/10″, 1/16, mm, cm, etc. . . . ) used in the construction and survey industry.

Another disadvantage prior art grade rods is the human error that often occurs in estimating and transferring the reference position onto the grade rod. This can result in considerable expense and frustration for the user.

Another disadvantage of prior art grade rods stems from their geometry, which makes them long, cumbersome, and inconvenient to transport to specific areas on the site. For example, with concrete flatwork it is often desirable to use a laser light receiver to verify tolerances while the concrete is being placed. In this situation, use of a graduated rod is difficult since there is nowhere to place the rod when not in use, and walking through wet concrete is highly undesirable.

Another disadvantage of prior art grade rods is the limitations in the maximum distance they are able to measure between the laser plane and a given surface. This is because at some point a graduated rod becomes too long to be manageable.

Another disadvantage in prior art grade rods is the difficulty involved in measuring the distance between the laser plane and a given surface located above the laser plane. Measuring the distance between the laser plane and a given surface above the laser plane is desirable to verify whether ceilings, beams, pipes or other construction members located above the laser plane are level or have a predetermined slope. This is made difficult by prior art grade rods since they require holding the grade rod in the air while adjusting the laser light detector up and down the graduated rod in order to center the laser plane on the reference position. In many cases the target surface is located too far above the reference beam for a grade rod to be used.

Another disadvantage of prior art grade rods is their inability to provide relative measurements and mathematically manipulate current measurements in relation to past measurements. In the construction and survey industries, it often more desirable to know the relative distance (i.e., the differences in heights between two points on the target surface) rather than a sequence of measurements that provide the distance between the laser plane and various points on the target surface.

Still another disadvantage of prior art grade rods is that they must be held plumb in order for an accurate vertical height measurement to be determined.

The foregoing background discussion reflects the current state of the art of which the present inventor is aware. Reference to, and discussion of, the prior art methods and systems is intended to aid in discharging Applicant's acknowledged duty of candor in disclosing information that may be relevant to the examination of claims to the present invention. However, it is respectfully submitted that none of the known art discloses, teaches, suggests, shows, or otherwise renders obvious the invention described and claimed herein.

### BRIEF SUMMARY OF THE INVENTION

Accordingly, it is a principal purpose of the present invention to provide a grade rod integrated into a laser distance measuring system, which provides a measure of distance from the on grade position of an external laser receiver to a user-defined target point without requiring the use of a pole or rod to adjust the position of the external laser receiver on the grade rod or to interpret measurements.

Another object and advantage of the present invention is to provide a grade rod integrated with a gravity reference device, such that the grade rod need not be held plumb over the user-defined target in order to determine the vertical distance between the on grade position of the external laser receiver and the target point.

It is yet another object of the present invention to provide a grade rod integrated into a communications device, which will allow an external laser receiver with compatible communication abilities to send a command signal to capture a measurement when the laser receiver's on grade position is aligned with a laser plane; then, if the external laser receiver is of the kind that is able to substantially determine a measure of the distance the on grade position is either above or below the laser plane at substantially the same time that the command signal is sent, then this distance value will be relayed to provide a corrected distance, wherein the corrected distance is substantially equal to a measure of the distance from the point at which the laser receiver detected the laser plane (at the time the capture command was sent) to the user-defined target point.

Additional advantages and other novel features of the invention will be set forth in part in the description that follows and in part will become apparent to those skilled in the art upon examination of the following or may be learned with practice of the invention.

To achieve the foregoing and other advantages, and in accordance with a first preferred embodiment of the present invention, a grade rod is provided that comprises: a reference position aligned with the on grade position of an external laser receiver; a housing configured to accept the external laser receiver and to allow the external laser receiver's on grade position to be aligned with the reference position on the housing; a distance measuring device that uses a laser light receiver and at least one laser light photosensor, the distance measuring device used to substantially determine a first distance between the laser light photosensor and an external predetermined target point, the laser light photosensor generating a first signal if receiving reflected laser light energy from the laser light photosensor; a processing circuit that receives the first signal; and a display device to display measured distance values.

In a second preferred embodiment of the present invention, a grade rod is provided that comprises: a reference position aligned with the on grade position of an external laser receiver; a housing configured to accept the external laser receiver and to allow the external laser receiver's on grade position to be aligned with the reference position on the housing; a distance measuring device that uses a laser light receiver and at least one laser light photosensor, the distance measuring device used to substantially determine a first distance between the laser light photosensor and an external predetermined target point, the laser light photosensor generating a first signal if receiving reflected laser light energy from the laser light photosensor; a gravity sensor that generates a second signal that is substantially indicative of the housing's angular orientation with respect to gravity; a processing circuit that receives the first signal and the second signal; and a display device to display measured distance values.

In a third preferred embodiment of the present invention, a grade rod is provided that comprises: a reference position aligned with the on grade position of an external laser receiver; a housing configured to accept the external laser receiver and to allow the external laser receiver's on grade position to be aligned with the reference position on the housing; a distance measuring device that uses a laser light receiver and at least one laser light photosensor, the distance measuring device used to substantially determine a first distance between the laser light photosensor and an external predetermined target point, the laser light photosensor generating a first signal if receiving reflected laser light energy from the laser light photosensor; a communications device that generates a second signal when receiving a third signal from the external laser receiver; a processing circuit that receives the first signal and the second signal; and a display device to display measured distance values.

In a final, and fourth preferred, embodiment of the present invention, a grade rod is provided that comprises: a reference position aligned with the on grade position of an external laser receiver; a housing configured to accept the external laser receiver and to allow the external laser receiver's on grade position to be aligned with the reference position on the housing; a distance measuring device that uses a laser light receiver and at least one laser light photosensor, the distance measuring device used to substantially determine a first distance between the laser light photosensor and an external predetermined target point, the laser light photosensor generating a first signal if receiving reflected laser light energy from the laser light photosensor; a gravity sensor that generates a second signal that is substantially indicative of the housing's angular orientation with respect to gravity; a communications device that generates a third signal when receiving a fourth signal from the external laser receiver; a processing circuit that receives the first signal, the second signal, and the third signal; and a display device to display measured distance values.

Other advantages of the present invention will become apparent to those skilled in this art from the following description and drawings wherein there is described and shown a preferred embodiment of this invention in one of the best modes contemplated for carrying out the invention. As will be realized, the invention is capable of other modification in various, obvious aspects all without departing from the invention. Accordingly, the drawings and descriptions will be regarded as illustrative in nature and not as restrictive.

Other novel features characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

### BRIEF DESCRIPTION OF THE SEVERAL VIEWS OF THE DRAWINGS

The invention will be better understood and objects and advantages other than those set forth above will become apparent when consideration is given to the following detailed description thereof. Such description makes reference to the annexed drawings, wherein:

FIG. 1 is a front view of a distance measuring grade rod as constructed according to the principles of the present invention.

FIG. 2A is a top view of a distance measuring grade rod as constructed according to the principles of the present invention.

FIG. 2B is a bottom view of a distance measuring grade rod as constructed according to the principles of the present invention.

FIG. 2C is a rear view of a distance measuring grade rod as constructed according to the principles of the present invention.

FIG. 2D is a perspective view of a distance measuring grade rod as constructed according to the principles of the present invention

FIG. 3 is a front view of a distance measuring grade rod in use with an external laser receiver and its associated clamp as constructed according to the principles of the present invention.

FIG. 4 is a top plan view of a distance measuring grade rod in use with an external laser receiver and its associated clamp as constructed according to the principles of the present invention.

FIG. 5 is an upper right front perspective view of a distance measuring grade rod combined with a extendable pole in use with an external laser receiver and its associated clamp, as constructed according to the principles of the present invention.

FIG. 6 is a block diagram of the major internal electronics of a distance measuring grade rod as constructed according to the principles of the present invention.

FIG. 7 is a block diagram of the major internal electronics of a distance measuring grade rod as constructed according to the principles of the present invention.

FIG. 8 is a block diagram of the major internal electronics of a distance measuring grade rod as constructed according to the principles of the present invention.

FIG. 9 is a block diagram of the major internal electronics of a distance measuring grade rod as constructed according to the principles of the present invention.

FIGS. 10-13 are operational flowcharts showing use of the first through fourth preferred embodiments of the distance measuring grade rod of the present invention.

### DETAILED DESCRIPTION OF THE INVENTION

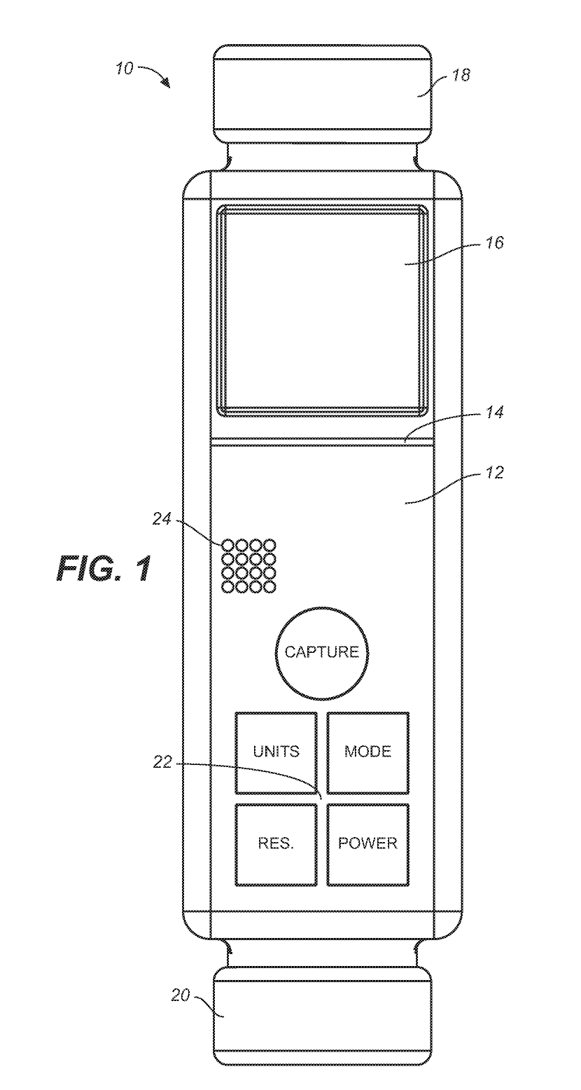

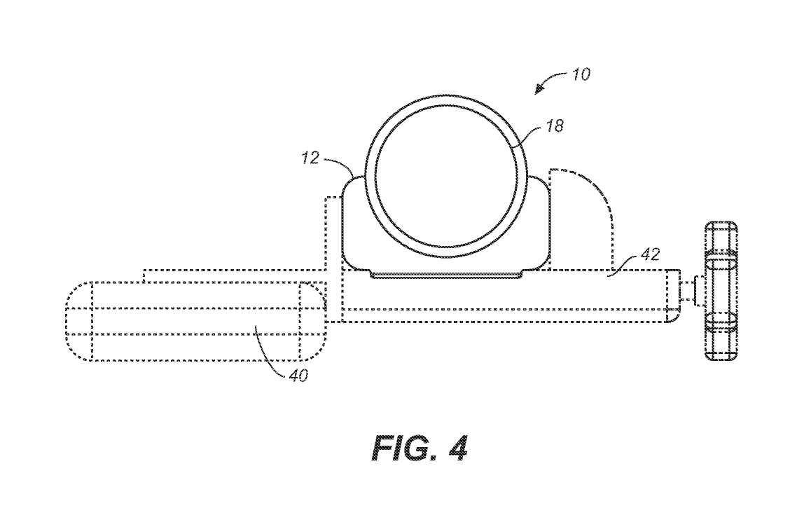

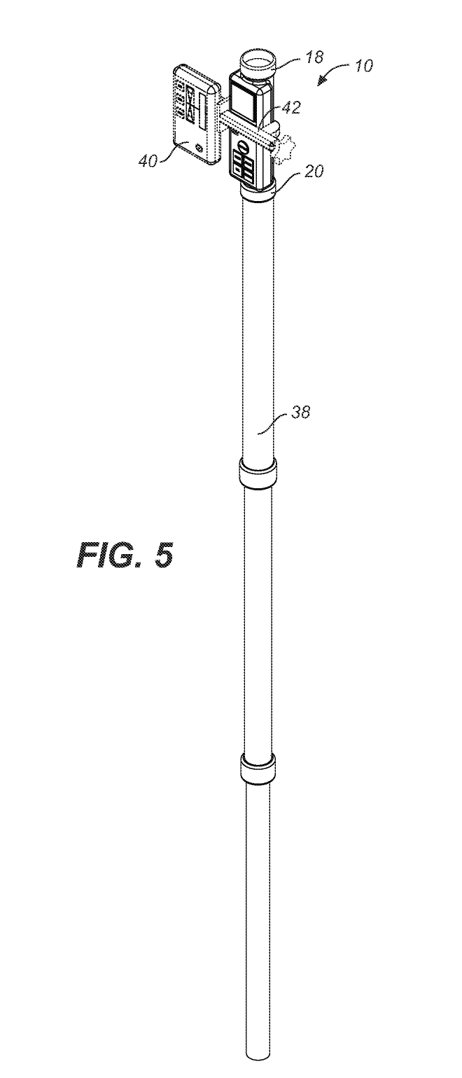

Referring first to FIGS. 1-9, wherein like reference numerals refer to like components in the various views, there is illustrated therein a new and improved laser distance measuring grade rod, generally denominated 10 herein.

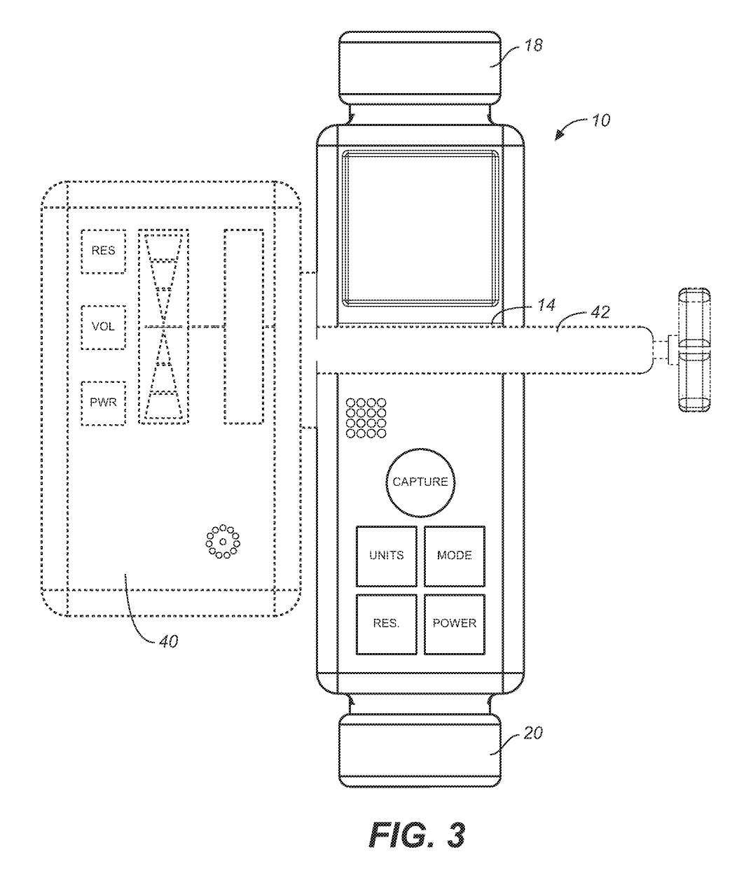

FIGS. 1-5, collectively, show that the inventive apparatus 10 includes a housing 12 typically fabricated from molded plastic and configured such that it is accessible to an external laser receiver 40 and to allow the on grade position of external laser receiver 40 to be aligned with reference line 14 as shown in FIG. 3. This configuration is enabled by constraining the width of housing 12 about reference line 14 to that of the maximum clamp capacity of a typical laser receiver clamp 42. This is approximately 2.25″. This configuration may also be accomplished using a mounting bracket with threaded holes for securing the laser receiver to the distance measuring grade rod apparatus 10. The external laser receiver 40 is then attached to the bracket such that its on grade position is aligned with reference line 14. Those with skill will immediately appreciate the many well-known ways of providing this structural configuration.

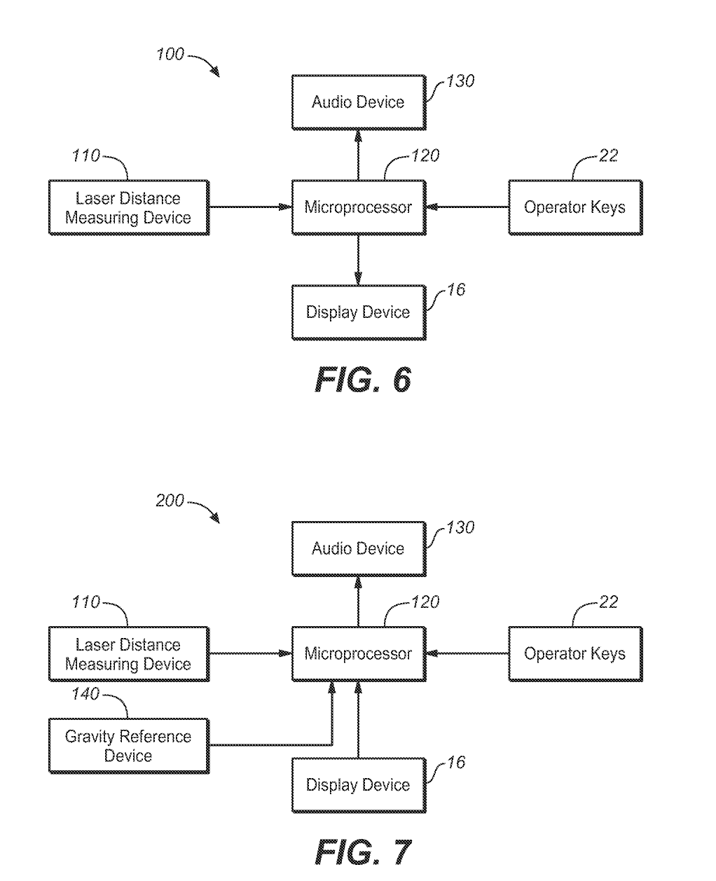

An annular upper pole mount 18 and an annular lower pole mount 20 are located on the top and bottom of housing 12 to allow the option of mounting apparatus 10 to an extendable pole 38. One or more openings 24 may be disposed on any of a number of locations on the housing or in upper pole mount 18 to allow for an acoustical output device, such as the audio device 130, shown schematically in FIGS. 6-9. A user interface with a set of user input keys 22 are located below these openings, allowing the user to apply power, input data, and to access certain functions of apparatus 10.

Located above the user input keys is a display 16, preferably a liquid crystal display (LCD), used to output measurements and provide useful system information, such as battery life, mode, acoustical output volume, units, and the like. A reference line 14 is located directly below display 16 and is used to properly align external laser receiver 40 with apparatus 10 such that accurate measurements from the on grade position of the external laser receiver 40 to a user-defined target point may be made.

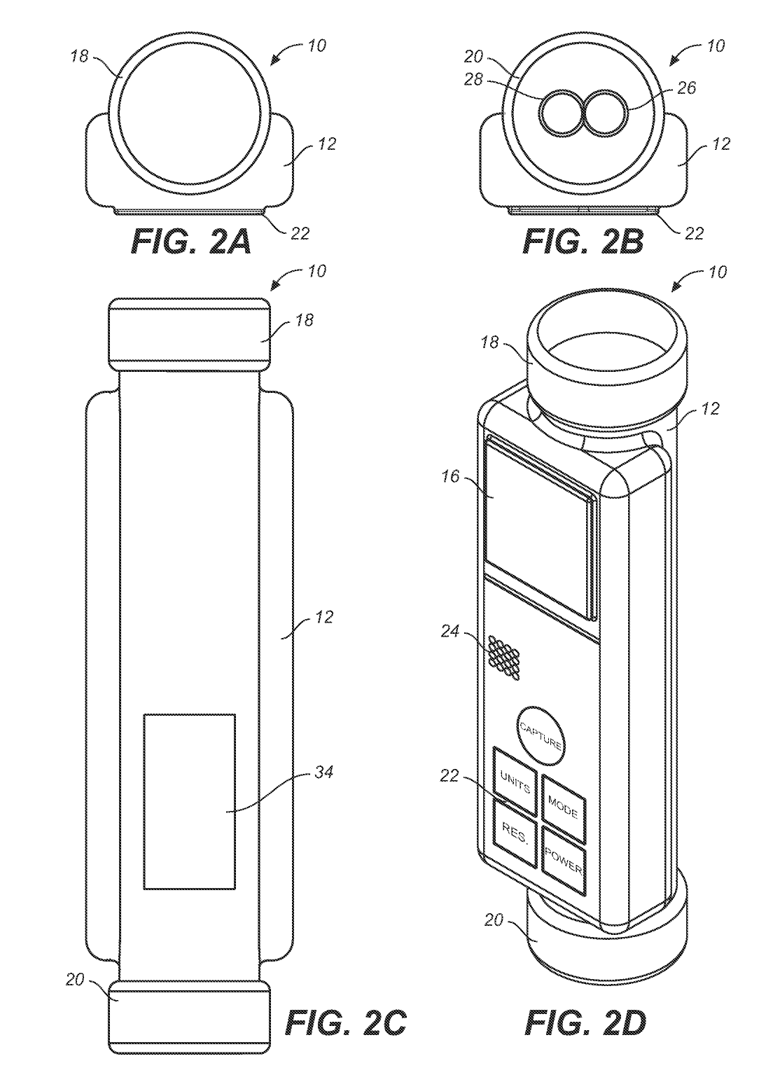

Referring now especially to FIG. 2B, a bottom view of the apparatus 10 is shown. In this view there is shown the lower pole mount 20 in which are disposed a first aperture 26 for allowing egress of transmitted energy, and a second aperture 28 for receiving reflections of the transmitted energy. It will be understood that the geometry and size of the lower pole mount 14 and the apertures 26 and 28 may be altered to enhance the ability to transmit and receive such energy. It will be further noted that the extendable pole 38 mounted to apparatus 10 using pole mounts 18/20 will be substantially hollow and without internal obstructions such that the transmitted energy may flow unimpeded through it. It will also be noted that apertures 26 and 28 may be located outside lower pole mount 14. However locating the apertures within the circumference of the lower pole mount at 26/28 allows the transmitted energy to be reflected off the bottom of the hollow extendable pole 38 (if used), which will be advantageous in referencing surfaces with small areas such as the top of a grade stick. In addition, the use of an extendable pole will allow measurements to be easily retained by locking the length of the pole. The housing 12 and user input keys 22 can also be seen.

FIG. 2C is a rear view of the apparatus 10 showing housing 12 and a battery compartment door 34. Regular, rechargeable, or solar cells may be used as the power source for the electronic circuits contained within housing 12. If solar cells are used, an aperture may be provided on housing 12 to receive solar energy. The upper and lower annular pole mounts, 18 and 20, respectively, can also be seen.

FIG. 2A is a top view of apparatus 10 showing housing 12 and the upper pole mount 18 with a geometry substantially equal to the lower pole mount 20.

FIG. 2D is a perspective view showing the inventive apparatus 10 mounted to extendable pole 38 that illustrates one possible geometry of housing 12 which has rounded corners and is sized to be comfortably held in one hand. While not shown in the above figures, a level vial can be positioned on housing 12 to assist the user in maintaining a plumb alignment during the measuring process. In addition, the above description applies to all of the various embodiments described below as they only differ in their internal electronics which are described in the block diagrams and in their functionality as described in the operation flowcharts.

FIGS. 6-9 are block diagrams depicting the functional units and operational elements of the internal electronics of first through fourth preferred embodiments of the present invention, 100, 200, 300, and 400, respectively. All of the embodiments employ a laser distance measuring device 110 that uses a laser light photosensor and laser light source to determine a first distance from the laser light photosensor to a user-defined target spot. There will also be a predetermined second distance defined as the distance from the laser light photosensor to reference line 14. A third distance is the sum of the first distance and the second distance and will be substantially equal to the distance from the on grade position of an external laser receiver to the user-defined target spot when the on grade position is aligned with reference line 14.

The laser distance measuring device may be configured to account for this fixed second distance in order to provide the third distance; alternatively microprocessor 120 may perform this task. There are many types of commercially available laser distance measuring devices. While some use a direct measurement of time of flight, most systems modulate a laser beam of light electronically and measure the degree of phase shift between the transmitted and reflected light. Avalanche photo diodes are typically used as photosensors to receive the reflected light due to their sensitivity to light which allows them to measure distant or dim objects or work without a special reflective target. The design of laser distance measuring device may take many forms known in the art, including those shown in U.S. Pat. Nos. 6,624,881 and 7,023,531, the disclosures of which are incorporated in their entirety by reference herein.

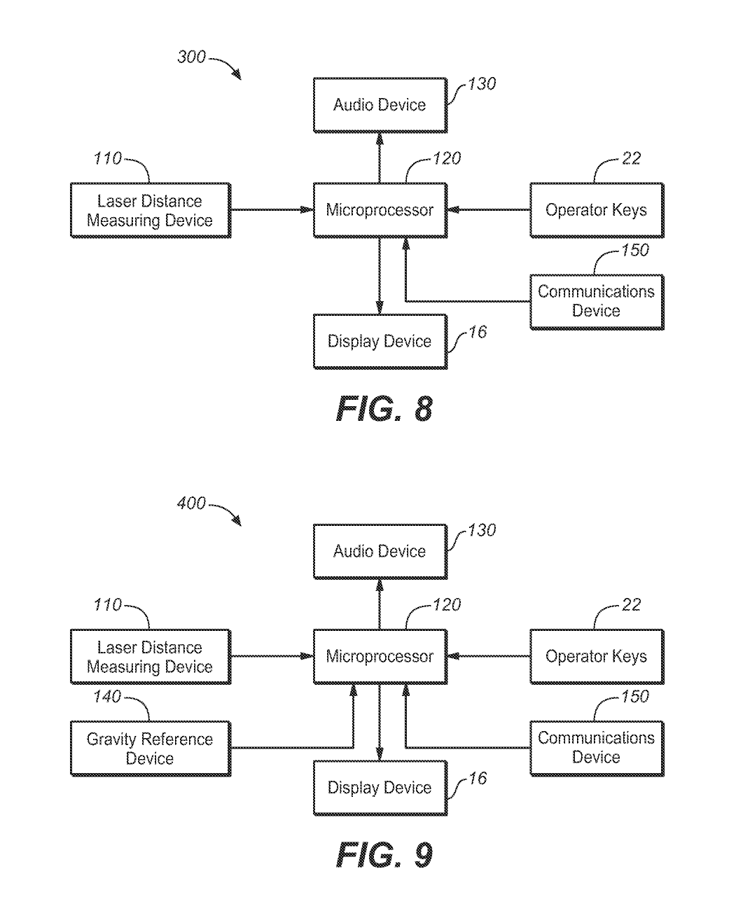

The third and fourth embodiments, shown in FIGS. 8-9, use a communications device 150, which allows the transfer of data and command signals between an external laser receiver with compatible communication abilities and microprocessor 120. This communication may be over a wire (i.e. serial, parallel) or wireless (i.e. infrared, Bluetooth, radio, etc.) taking many forms known in the art. If communication functionality is provided via wired means, then a cable receiver such as a phone or network jack may be provided on housing 12.

The second and fourth embodiments, shown in FIGS. 7 and 9, use a gravity sensor 140 that determines the angular orientation of the apparatus with respect to gravity. Typically, gravity sensors are accelerometers that determine the magnitude of a force along three mutually orthogonal axes. An exemplary accelerometer is found in the Analog Devices ADXL330. The gravity sensor 140 may be placed in housing 12. A suitable option is to locate the gravity sensor 140 at the base of extendable pole 38, as it would be less prone to spurious lateral acceleration in this location, thereby allowing it to stabilize more quickly. The user could be made aware of the gravity sensor 140 condition in relation to its stability by providing audio feedback. For example, a unique sound such as a beep could be produced at an increasing frequency as the gravity sensor 140 became more unstable and could be stopped when within tolerances. This feedback would alert the user if he/she were moving the device too quickly, thus indicating when it was possible to take an accurate measurement.

FIG. 6 is a block diagram illustrating the principal electronic units of a first preferred embodiment of the present invention. A laser distance measuring device 110 produces a first signal, indicative of a measured distance, which is sent to microprocessor 120. Operator keys 22 are also connected to microprocessor 120 and allow the user to capture a measurement, input data, and enable certain functions of device 10, typically via voltage loads. Upon receipt of the first signal and user inputs via operator keys 22, microprocessor 120 drives an acoustical output device 130 (typically a piezo electric speaker) and outputs a measured distance value to a display device 16 (typically a liquid crystal display). Microprocessor 120 will also process user inputs via user keys 22 to drive the audio device 130 if erroneous information is entered and will output system information to display 16, such as battery level, volume, mode, and so forth.

FIG. 7 is a block diagram illustrating the functional electronic units of a second preferred embodiment 200 of the present invention. A laser distance measuring device 110 produces a first signal, indicative of a measured distance, which is sent to microprocessor 120. A gravity reference device 140 produces a second signal indicative of the angular orientation of housing 12 with respect to gravity, and this signal is also sent to microprocessor 120. Microprocessor 120 combines the first and second signals and calculates the vertical measured distance value (i.e., the measured distance value if device 200 were held substantially plumb with respect to gravity over the target point). Operator keys 22 are also connected to microprocessor 120 and allow the user to capture a measurement, input data, and enable certain functions of device 200. Upon receipt of the first signal and second signal, and in response to user inputs, microprocessor 120 drives an acoustical output device 130 and outputs a measured distance value to display 16. Microprocessor 120 will also process user inputs via user keys 22 to drive the audio device 130 for example if erroneous information is entered and output system information to display 16 such as battery level, volume, mode, the so forth.

FIG. 8 is a block diagram illustrating the principal electronic elements of a third preferred embodiment 300 of the present invention. A laser distance measuring device 110 produces a first signal, indicative of a measured distance, which is sent to microprocessor 120. A communications device 150 connected to microprocessor 120 produces a third signal in the form of data and command signals sent from an external compatible laser receiver. If the external compatible laser receiver has the ability to pass data in the form of an offset value (which is a measure of distance the laser plane is above or below the laser receiver's on grade position at the time the capture command was sent), then microprocessor 120 will use the offset value to compute and output a “corrected first distance” value, wherein the corrected first distance is substantially equal to a measure of distance from where the laser receiver detected the laser plane (at the time the capture command was sent) to the user-defined target point. If the laser receiver has the ability to pass command signals, such as a “capture measurement” command, then microprocessor 120 will treat the command signals as it does with equivalent user commands. Operator keys 22 are also connected to microprocessor 120 and allow the user to capture a measurement, input data and enable certain functions of device 300. Upon receipt of the first and third signals, and at times user inputs via operator keys 22, microprocessor 120 drives an acoustical output device 130 and outputs a measured distance value to display 16. Microprocessor 120 will also process user inputs via user keys 22 to drive the audio device 130, such as when erroneous information is entered, and will produce an output of selected system information to display 16, including such information as battery level, volume, mode, and so forth.

FIG. 9 is a block diagram illustrating the principal electronic elements of a fourth preferred embodiment 400 of the present invention. A laser distance measuring device 110 produces a first signal, indicative of a measured distance, which is sent to microprocessor 120. A gravity reference device 140 produces a second signal indicative of the angular orientation of housing 12 with respect to gravity, and it sends this second signal to microprocessor 120. Microprocessor 120 combines the first and second signals to calculate the vertical measured distance value (again, the measured distance value if device 400 were held substantially plumb with respect to gravity over the target point). A communications device 150 connected to microprocessor 120 produces a third signal in the form of data and command signals sent from an external compatible laser receiver. If the laser can pass data in the form of an offset value, as defined above, then microprocessor 120 will use the offset value to compute and output a corrected first distance value. If the laser receiver can pass command signals, then microprocessor 120 will treat the command signals as it does equivalent user commands. Operator keys 22 are also connected to microprocessor 120 and allow the user to capture a measurement, input data and enable certain functions of device 400. Upon receipt of the first through third signals, as well as user inputs, microprocessor 120 drives an acoustical output device 130 and outputs a measured distance value to display 16.

It will be understood that the precise circuits depicted in the above block diagrams, and discussed in this specification, could be modified to perform similar, although not exact, functions and mathematical operations without departing from the principles of the present invention.

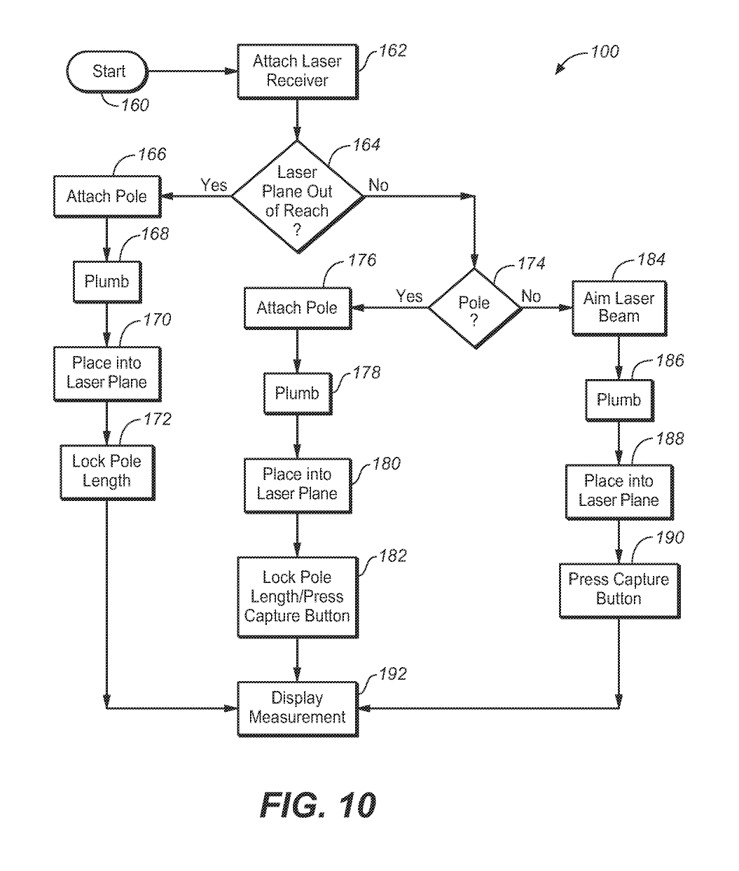

FIGS. 10-13 are schematic flow charts showing the method steps employed in using the above-described first through fourth preferred embodiments of the inventive apparatus.

FIG. 10 is a flowchart showing the operation of the first preferred embodiment of the present invention. Apparatus 10 with electronics 100 (FIG. 6) is turned on at 160. At 162 the user attaches an external laser receiver 40 to outer housing 12 such that the on grade position of the external laser receiver 12 is aligned with reference line 14 (see also FIGS. 1-5). In this configuration the distance from the reference line 14 to the target point will substantially equal the distance from the on grade position of the laser receiver 40 to the target point. The user then determines if the laser plane is outside arm's reach at 164.

If the laser plane is outside arm's reach, the user next attaches 166 the extendable pole 38 to lower pole mount 20 and plumbs 168 the extendable pole by placing the base of extendable pole 38 over a given target point. Due to the thickness of the platform or base on extendable pole 12 is placed, the user will enter a mode via a key press or combination of key presses of user keys 22 that will inform microprocessor 120 to compensate for the base thickness in its measurements. Magnetic sensors can be provided to automatically detect the pole presence and relieve the user of the need to manually enter this mode. While maintaining a plumb alignment, the housing is placed into the laser plane 170 until audio or visual indicators on the laser receiver confirm that an on grade position has been achieved. The pole length is then locked 172.

If the laser plane is not outside arm's reach at decision block 174, then the user has the option of not using the extendable pole at 174. Often it will be more convenient to use the extendable pole as it helps in stabilizing housing 12 and accessing target points with small surface areas, such as the top of grade stakes. (Pointing a laser beam at such a small target is difficult.) However, in some circumstances such as when determining if large expanses of wet concrete are on grade, using the extendable pole is difficult. In these situations the user will choose “NO” at 174 and proceed to block 184 where the user will aim device 10 at a given target point. Laser distance measuring devices often include a visual marking device that produces an easily seen beam of light to aid the user in aiming the device at a given target point. At 186 the user carefully plumbs housing 12 over the given target point. At 188 the user moves housing 12, while still being careful to maintain a plumb alignment and to assure that the visual marker is still pointing at the given target point. The user continues moving the housing until it is in the laser plane and the on grade position is confirmed by audio or visual indicators on laser receiver 40. The measurement is captured via user input keys 22 at block 190, and this value is displayed at 192.

Still referring to FIG. 10, if the user chooses YES at 174, the user attaches the extendable pole 12 to lower pole mount 20 and at block 176 attaches the pole the pole base over a given target point. The user will also enable a mode that compensates for the thickness of the base of extendable pole 38, as noted above. Care is taken to plumb this arrangement over the target point at 178. At block 180 the user begins moving housing 12 into the laser plane, while taking care to maintain a plumb alignment until audio or visual indicators on laser receiver 40 confirm its on grade position. The user then locks the length of the extendable pole 38 and presses the Capture button at block 182. This will retain the measurement as noted above. However, since the laser plane is in reach the user will also have the option of depressing one of the user keys 22 to capture and retain a measurement. The measurement is then displayed at 192.

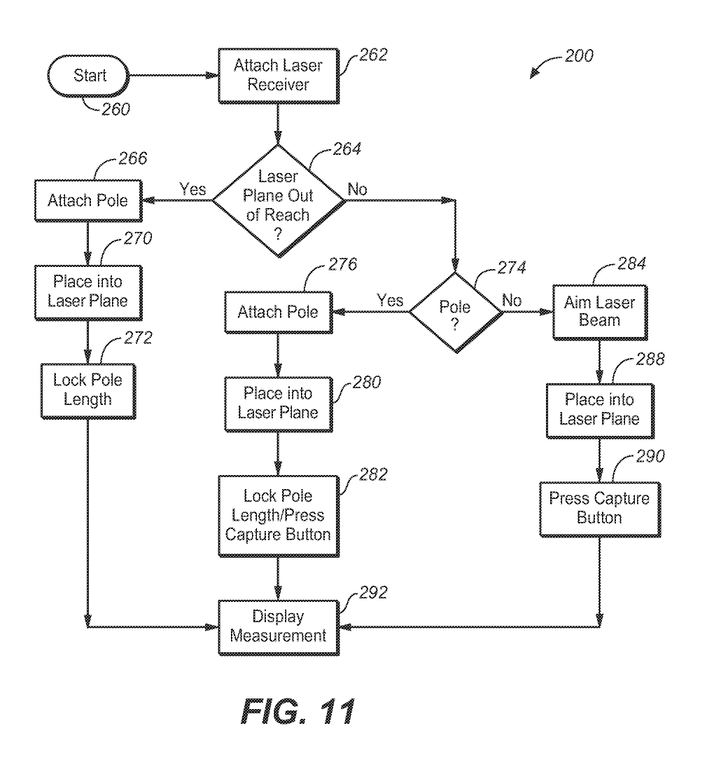

FIG. 11 is a flowchart showing operation of the second embodiment of the present invention. Apparatus 10, with electronics 200 (FIG. 7) is turned on at 260. At 262 the user attaches an external laser receiver 40 to outer housing 12 such that the on grade position of the external laser receiver 12 is aligned with reference line 14. In this configuration the distance from the reference line 14 to the target point will substantially equal the distance from the on grade position of the laser receiver 40 to the target point. The user then determines if the laser plane is outside arm's reach at 264.

If the laser plane is outside arm's reach, at block 266 the user attaches the extendable pole 38 to lower pole mount 20 and places the base of extendable pole 38 over a given target point. Due to the thickness of the base of extendable pole 12, the user will enter a mode via a key press or combination of key presses of user keys 22 that will inform microprocessor 120 to compensate for the base thickness in its measurements. In contrast to the first preferred embodiment, the user is not required to hold the assembly plumb because gravity reference device 140 detects the angular orientation of housing 12 and supplies this data to microprocessor 120. Microprocessor 120 combines this data with data received from laser distance measuring device 110 to mathematically determine what the measured distance value (distance from reference line 14 to the target point) would be if the assembly were held substantially plumb over the target point. At block 270 the user begins moving housing 12 into the laser plane until audio or visual indicators on laser receiver 40 confirm that the on grade position is aligned with the laser plane. At block 272 the user then locks the length of the extendable pole 38. This will retain the measurement, since the output of laser distance measuring device 110, in this arrangement, will only change if the length of extendable pole 38 varies. The measurement is then displayed at 292.

If the laser plane is not outside arm's reach at decision block 264, then the user has the option of not using the extendable pole at decision block 274 and NO is entered via user inputs and the user proceeds to block 284 where the user will aim device 10 at a given target point. At block 288 the user begins moving housing 12 while ensuring that the visual marker is still pointing at the given target point. The user continues moving the housing in the laser plane until audio or visual indicators on laser receiver 40 confirm that its on grade position is aligned with the laser plane. The measurement is captured via user keys 22 at 290 and this value is displayed at 292.

Still referring to FIG. 11, if the user chooses YES at decision block 274, at block 276 the user attaches the extendable pole 12 to lower pole mount 20, places the base of extendable pole 12 over a given target point, and enables a mode that compensates for the thickness of the pole base. Again, in contrast to the first preferred embodiment, the user is not required to hold the assembly plumb due to the inclusion of gravity reference device 140. At block 280 the user begins moving housing 12 into the laser plane until audio or visual indicators on laser receiver 40 confirm that its on grade position is aligned with the laser plane. The user then locks the length of the extendable pole 38 and presses the Capture button at block 282, which will retain the measurement as noted above. However, since the laser plane is in reach, the user will also have the option of depressing one of the user keys 22 to capture and retain a measurement. The measurement is then displayed at 292.

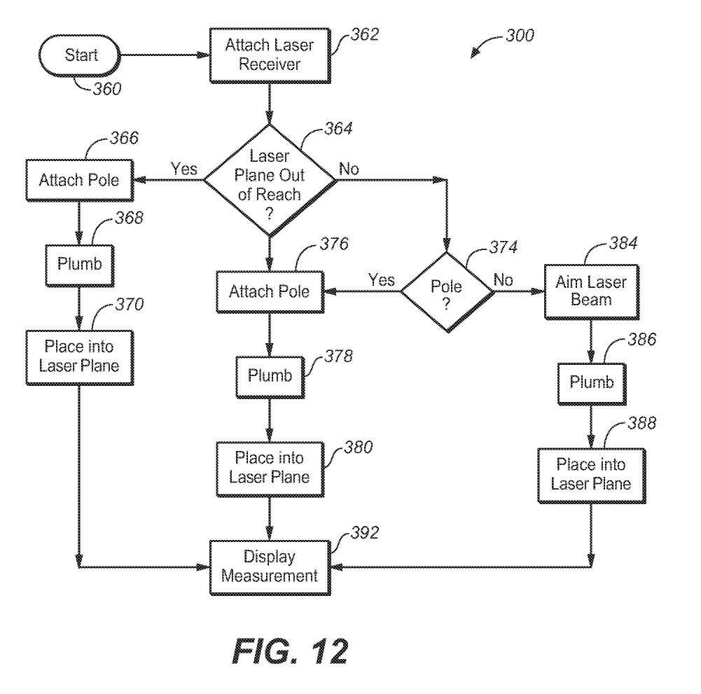

FIG. 12 is a flowchart showing operation of the third embodiment of the present invention. Device 10 with electronics 300 (FIG. 8) is turned on at 360. At block 362 the user attaches an external laser receiver 40 to outer housing 12 such that the on grade position of the external laser receiver 12 is aligned with reference line 14. In this configuration the distance from the reference line 14 to the target point will substantially equal the distance from the on grade position of the laser receiver 40 to the target point. The user then determines if the laser plane is outside arm's reach at decision block 364. As this third preferred embodiment has communication functionality, the user will also attach a communications cable between the communications device 150 and external laser receiver 12 at block 362. However, if communication is provided wirelessly, then this sub-step is not required.

The user then determines if the laser plane is outside arm's reach at 364. If the laser plane is outside arm's reach, the user attaches the extendable pole 38 to lower pole mount 20 and places the base of extendable pole 38 over a given target point at block 366. The user will also enter a mode via a key press or combination of key presses of user keys 22 that will inform microprocessor 120 to compensate for the base thickness in its measurements. Care is taken to plumb this arrangement over the target point at block 368. At block 370 the user begins moving housing 12 into the laser plane, all the while being careful to maintain a plumb alignment. He continues this movement until audio or visual indicators on laser receiver 40 confirm that its on grade position is aligned with the laser plane. The user is not required to lock the length of extendable pole 38 as in the first and second embodiments because the communication device 150 will relay the capture command from the compatible external laser receiver to microprocessor 120. If the compatible laser receiver is able to determine the distance the laser plane was above or below the on grade position at the time the capture command is sent, then this offset value will be sent along with the capture command. Microprocessor 120 will then use this value to compute and output a corrected first distance value, wherein the corrected first distance is substantially equal to a measure of the distance from the point the laser receiver detects the laser plane (at the time the capture command was sent) to the user-defined target point. Either way, the capture command will cause microprocessor 120 to compute the measured distance and will display it at 392.

If the laser plane is not outside arm's reach at 364, then the user has the option of not using the extendable pole at decision block 374 and responds with NO. The user will then proceed to 384 where the user will aim device 10 at a given target point. At block 386 the user is careful to plumb housing 12 over the given target point. At block 388 the user begins moving housing 12 into the laser plane while simultaneously maintaining a plumb alignment and assuring that the visual marker remains aimed at the given target point. He continues in this manner until audio or visual indicators on laser receiver 40 confirm that its on grade position is aligned with the laser plane. The user is not required to manually capture a measurement via a key press as in the first and second embodiments and the measured distance value will automatically be displayed at 392.

Still referring to FIG. 12, if the user chooses yes at 374, at block 376 the user next attaches the extendable pole 12 to lower pole mount 20, places the base of extendable pole 12 over a given target point, and enables a mode that compensates for the thickness of the pole base. The arrangement is plumbed over the target point at 368. At block 370 the user begins moving housing 12 into the laser plane, while simultaneously being careful to maintain a plumb alignment, until audio or visual indicators on laser receiver 40 confirm that its on grade position is aligned with the laser plane. Due to the inclusion of communication device 150, the measurement will be automatically captured and displayed at 392.

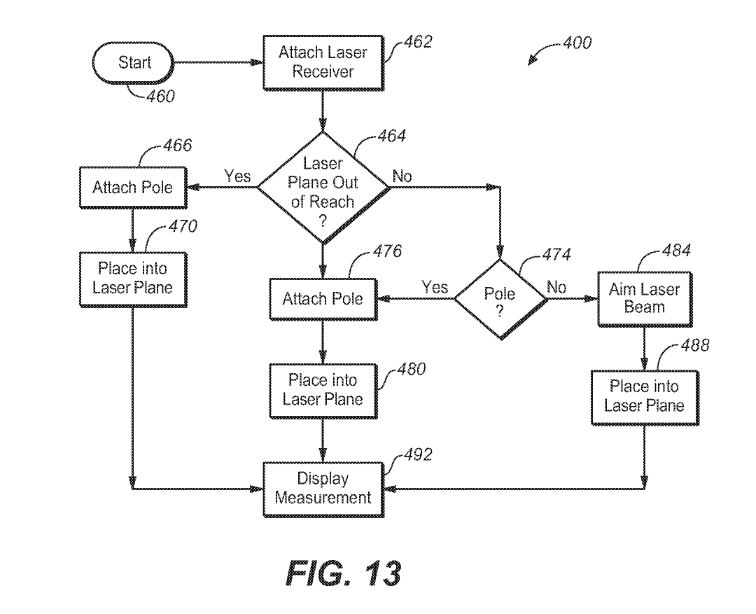

FIG. 13 is a flowchart showing operation of the fourth embodiment of the present invention. Apparatus 10 with electronics 400 (FIG. 9) is turned on at 460. At 462 the user attaches an external laser receiver 40 to outer housing 12 such that the on grade position of the external laser receiver 12 is aligned with reference line 14. In this configuration the distance from the reference line 14 to the target point will substantially equal the distance from the on grade position of the laser receiver 40 to the target point. As this embodiment has communication functionality, the user will also attach a communications cable between the communications device 150 and external laser receiver 12. However, if communication is provided wirelessly then this step is not required.

At decision block 464 the user next determines if the laser plane is outside arm's reach. If the laser plane is outside arm's reach, at block 466 the user attaches the extendable pole 38 to lower pole mount 20, places the base of extendable pole 38 over a given target point, and enters a mode via a key press or combination of key presses of user keys 22 that will inform microprocessor 120 to compensate for the pole base thickness in its measurements. In contrast to the first and third embodiments, the user is not required to hold the assembly plumb as the gravity reference device 140 detects the angular orientation of housing 12 and supplies this data to microprocessor 120. Microprocessor 120 combines housing angular orientation data with data received from laser distance measuring device 110 to mathematically determine what the measured distance value would be if the assembly were held substantially plumb over the target point. At block 470 the user begins moving housing 12 into the laser plane until audio or visual indicators on laser receiver 40 confirm that its on grade position is aligned with the laser plane. The user need not lock the length of extendable pole 38, as is required by the first and second embodiments, because the communication device 150 will relay the capture command from the compatible external laser receiver to microprocessor 120. If the compatible laser receiver is able to determine the distance the laser plane is above or below the on grade position at the time the capture command is sent, then this offset value will be sent along with the capture command.

Microprocessor 120 will then use the offset value to compute and output a corrected first distance value, wherein this corrected first distance value is substantially equal to a measure of the distance from the point where the laser receiver detected the laser plane (at the time the capture command was sent) to the user-defined target point. Either way, the capture command will cause microprocessor 120 to compute the measured distance and display it at 492.

If the laser plane is not outside arm's reach at 464, then the user may elect not to use the extendable pole at decision block 474 and therefore chooses NO. He then proceeds to block 484 where he aims device 10 at a given target point. At block 488 the user begins moving housing 12 into the laser plane, while simultaneously ensuring that the visual marker is still aimed at the given target point, until audio or visual indicators on laser receiver 40 confirm that its on grade position is aligned with the laser plane. The user need not manually capture a measurement via a key press as in the first and second embodiments, and the measured distance value will automatically be displayed at 492.

Still referring to FIG. 13, if the user chooses YES at decision block 474, at block 476 the user attaches the extendable pole 12 to lower pole mount 20, places the base of extendable pole 12 over a given target point, and enables a mode that compensates for the thickness of the base of extendable pole. Again, in contrast to the first and third embodiments, the user is not required to hold the assembly plumb due to the inclusion of gravity reference device 140. At block 480 the user begins moving housing 12 into the laser plane until audio or visual indicators on laser receiver 40 confirm that its on grade position is aligned with the laser plane. Due to the inclusion of communication device 150 the measurement will be automatically captured and displayed at 492.

All of the above embodiments also have the ability to reference target points that reside above the reference plane. This is enabled by attaching the extendable pole 38 to upper pole mount 18 such that the transmitting laser light beam of the laser distance measuring device 110 is pointing upward. From this point, operation continues as if referencing target points below the laser plane as set out in the above-described operational flowcharts.

Due to the processing abilities common to the preferred embodiments, various functions or modes could be enabled as follows. One possibility is to enable an option to scan for the minimum distance measurement during a predetermined amount of time during the measuring process. Due to simple geometry this would provide the user with a measured distance value that corresponds to the extendable pole position or a transmission path that is the most plumb during the predetermined amount of time. This would apply only to horizontal laser reference planes.

Another possibility is to include a relative mode in which the user takes an initial measurement from some user-defined position and every subsequent measurement is the difference between that measurement and the initial reference measurement. This provides the user with the exact value needed to raise/lower a member to bring it level or to cut/fill to bring a given surface to grade without requiring the user to record or remember the measurements and then subtract grade rod measurements.

An offset function may be provided as well, which works as follows. There are times when there does not exist a single point on the job site that is on grade and any initial measurement point chosen in relative mode will also require an initial cut/fill value. An offset function handles this situation by allowing the user to input this initial cut/fill value, and the system will then add/subtract the value (depending on whether the initial value is a cut or a fill) to every subsequent measurement in relative mode. While this function is useful in the construction industry, the survey industry will benefit as well. One of the primary roles of a surveyor is to determine elevations. Prior art methods require a surveyor to take an initial measurement at some point with a known elevation, subtract subsequent measurements from this initial measurement and finally add this difference value to the known elevation to determine the new elevation at this point. The combination of relative mode with the offset function handles this situation quite easily as the difference values are equivalent to cut/fill values and the known elevation is equivalent to the offset value. The surveyor simply enters relative mode and inputs the known elevation as a value into the offset function. The surveyor then takes an initial measurement at the point of known elevation, and this embodiment will output the total elevation at any point the surveyor subsequently chooses.

Yet another option is to include GPS (Global Positioning System) and/or communication (Bluetooth, infrared, radio, etc.) functionality such that a communication link can be established with another device such as a laptop computer.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A distance measuring grade rod for use with a laser distance measuring system, comprising:
a housing having a reference line, a user interface with user input keys, a visual output display, a reference line disposed below said visual output display, and upper and lower pole mounts;
attachment apparatus for attachment of said housing to an external laser receiver such that the on grade position of the external laser receiver is aligned with said reference line;
an audio output device disposed in said housing;
a first aperture for allowing egress of transmitted energy;
a second aperture for receiving reflections of the energy transmitted through said first aperture;
a gravity sensor for determining the angular orientation of said housing with respect to gravity; and
system electronics disposed within said housing and including a laser distance measuring device that uses a laser light photosensor and laser light source to determine a first distance from the laser light photosensor to a user-defined target spot, a microprocessor that employs a predetermined second distance defined as the distance from the laser light photosensor to reference line to calculate a third distance, which is the sum of the first distance and the second distance and which is substantially equal to the distance from the on grade position of the external laser receiver to the user-defined target spot when the on grade position of the external laser receiver is aligned with said reference line.

2. The apparatus of claim 1, further including a communications device, which allows the transfer of data and command signals between the external laser receiver and said microprocessor.

3. The apparatus of claim 1, wherein said communications device sends a command signal to capture a measurement when on grade position of the external laser receiver is aligned with a laser plane.
